(19) United States
(12) Patent Application Publication
(10) Pub. No.: US 2024/0376775 A1
(43) Pub. Date: Nov. 14, 2024

(54) Motorized Electric Shades with Wireless Energy Transport

(71) Applicant: OLIBRA LLC, Cresskill, NJ (US)

(72) Inventors: Zohar Shinar, Demarest, NJ (US); Christopher Andrew Merck, Sussex, NJ (US)

(21) Appl. No.: 18/195,417

(22) Filed: May 10, 2023

(51) Int. Cl. E06B 9/68; E06B 9/72

(52) U.S. Cl. CPC E06B 9/68; E06B 9/72; E06B 2009/6809

(57) ABSTRACT

A motorized electric shade system has an indoor electric motor that controls an indoor shade element, such as blind panels or a retractable and expandable window screen. The indoor electric motor receives power over a wire from a nearby indoor rechargeable battery. The indoor rechargeable battery receives power from an outdoor power source, such as an external solar panel, without the need to drill or utilize holes or tunnels in any wall or window of the venue. Rather, a Qi (or other) wireless energy transmitter is located adjacently to the external side of the glass window; and a Qi (or other) wireless energy receiver is located adjacently to the internal side of the glass window; and the outdoor-generated or solar-generated electric power is transported wirelessly from the outdoor Qi transmitter to the indoor Qi receiver, across and through the glass window. The Qi transmitter and the Qi receiver are attached to the two sides of the window via one or more attachment or support mechanisms.

### FIELD Some embodiments are related to the field of motorized electric shades.

### BACKGROUND

Millions of people live in houses or apartments that have windows. A window is typically made of transparent glass, and can protect the indoor occupants from rain or snow or wind, while still allowing the indoor occupants to view the outdoors scenery (e.g., a street, a yard, a lawn).

People sometimes cover a with a curtain, for various purposes: to block sunlight when it is too bright and sunny, to maintain privacy, for decorative purposes, or for other reasons.

### SUMMARY

Some embodiments include a motorized electric shade, having an indoor electric motor and an indoor shade element (e.g., blind panels or a retractable/expandable window screen). The indoor shade element is controlled by the indoor electric motor. The indoor electric motor receives power over a wire from a nearby indoor rechargeable battery. The indoor rechargeable battery receives power from an outdoor/external power source, such as an external photovoltaic/solar panel, without the need to drill or utilize holes or tunnels in any wall or window. Rather, a Qi (or other type of) wireless energy transmitter is located adjacently to the external side of the window; and a Qi (or other type of) wireless energy receiver is located adjacently to the internal side of the window; and the outdoor-generated/solar-generated electric power is transported wirelessly from the Qi transmitter to the Qi receiver, across and through the glass window. The Qi transmitter and the Qi receiver are attached to the window via one or more attachment mechanisms; for example, by gluing or bonding, using adhesive tape, by suction cup/vacuum cup, by being hang over a nail or a screw like a hanging painting, or other mechanical connection mechanism or holding mechanism or support mechanism.

Some embodiments may similarly transport energy, in a wireless manner, across a glass window (or other type of window or thin barrier or thin wall), without requiring to drill or to form or to use any holes or tunnels through such window/barrier/wall; and can provide electric energy that was produced or generated at a first side of that window/barrier/wall (or that was delivered via a wire to that first side), via such wireless energy transport channel through the window/barrier/wall, to an energy consuming device (e.g., electric device, electronic device, appliance) or an energy storing device (e.g., rechargeable battery/power cell/power bank) located at a second, opposite, side of that window/barrier/wall.

### BRIEF DESCRIPTION OF THE DRAWINGS

FIG. 1A is a schematic illustration of a system, in accordance with some demonstrative embodiments; demonstrating a venue having a wireless through-the-glass-window energy transmission mechanism, which provides electric power to an indoor motor of an indoor electric shades unit.

FIG. 1B is a schematic illustration of another system, in accordance with some demonstrative embodiments; demonstrating a venue having a wireless through-the-glass-window energy transmission mechanism, which provides electric power to an indoor motor of an indoor electric shades unit; and further demonstrating a solar panel with a rotating/pivoting/gimbaling mechanism located outdoor, connected to or mounted on an external side of a wall of the venue.

FIG. 1C is a schematic illustration of another system, in accordance with some demonstrative embodiments; demonstrating a venue having a wireless through-the-glass-window energy transmission mechanism, which provides electric power to an indoor motor of an indoor electric shades unit; and further demonstrating a solar panel with a rotating/pivoting/gimbaling mechanism located outdoor, connected to or mounted on a roof (or roof shingles) of the venue.

FIG. 1D is a schematic illustration of another system, in accordance with some demonstrative embodiments; demonstrating a venue having a wireless through-the-glass-window energy transmission mechanism, which provides electric power to an indoor motor of an indoor electric shades unit, after firstly charging an outdoor rechargeable battery.

FIG. 1E is a schematic illustration of another system, in accordance with some demonstrative embodiments; demonstrating a venue having a wireless through-the-glass-window energy transmission mechanism, which provides electric power to an indoor motor of an indoor electric shades unit, after firstly charging an indoor rechargeable battery.

FIG. 1F is a schematic illustration of another system, in accordance with some demonstrative embodiments; demonstrating a venue having a wireless through-the-glass-window energy transmission mechanism, which provides electric power to an indoor rechargeable battery, which in turn provides electric power to one or more indoor appliances or electronic devices or electric devices.

FIG. 1G is a schematic illustration of another system, in accordance with some demonstrative embodiments; demonstrating a venue having a wireless through-the-glass-window energy transmission mechanism, which firstly charges an outdoor rechargeable battery and then provides electric power to an indoor rechargeable battery, which in turn provides electric power to one or more indoor appliances or electronic devices or electric devices.

FIG. 2A is a schematic illustration of a Qi wireless energy transmitter or receiver, or other wireless energy transmitter or receiver unit, that is structured as a decorative object (e.g., a decorative star), hanging on a screw/nail/pin that is on a wall of a venue having a window, in accordance with some demonstrative embodiments.

FIG. 2B is a schematic illustration of a Qi wireless energy transmitter or receiver, or other wireless energy transmitter or receiver unit, structured as a suction cup/vacuum cup having a region or tail or extension with copper coils or metal coils, in accordance with some demonstrative embodiments.

FIG. 2C is a schematic illustration of a Qi wireless energy transmitter or receiver unit, surrounded by a large magnetic ring that can hold it to a window via magnetic force, in accordance with some demonstrative embodiments.

FIG. 2D is a schematic illustration of a Qi wireless energy transmitter or receiver unit, hanging below a large magnetic holding element that can hold it to a window via magnetic force, in accordance with some demonstrative embodiments.

### DETAILED DESCRIPTION OF SOME DEMONSTRATIVE EMBODIMENTS

The Applicant has realized that installing a motorized electric shade can be a difficult task, for average users and also for professionals and technicians; and can be time-consuming, effort-consuming, error-prone, or overly complicated.

The Applicant has realized that many types of motorized electric shade require supply of mains electricity, and therefore require a licensed electrician to visit the home or venue and to create a safe and reliable wired electric connection to the mains electricity network of the home or venue. This may require, for example, drilling holes or tunnels through holes, running electric cables or wires inside walls (very difficult) or on walls/ceilings/floors (non-decorative appearance, and sometimes also a tripping hazard).

The Applicant has realized that a motorized electric shade may be powered by a replaceable battery; however, such battery would typically run out of power within days, and would require frequent replacement by the user, which causes inconvenience and which requires the user to obtain and keep an inventory of replacement batteries.

The Applicant has realized that a motorized electric shade may be powered by a rechargeable battery, which in turn may receive electric power from a solar panel. However, realized the Applicant, such configuration may suffer from disadvantages.

In a first scenario, realized the Applicant, a solar panel is installed outdoors, such as on an external wall of the venue; while the motorized electric shade and its electric motor are located indoors, within the venue. Therefore, realized the Applicant, a hole or tunnel must be drilled or formed in a wall of the venue, in order to supply (via an electric cable) the electric power that was generated outdoor, to the electric motor that is located indoors. Such hole-drilling can be difficult for many users, and/or may be undesired to many users who are reluctant to introduce holes to the walls or of their home (often accompanied by visible running cables) for the particular purpose of operating a motorized electric shade.

In a second scenario, realized the Applicant, a solar panel may be located indoors, next to a glass window, and may provide electric power over a wire to the motorized electric shade. However, in this scenario, realized the Applicant: First, some users do not wish to have a solar panel inside their living room or bedroom. Second, some users may agree to install only a small-size solar panel, whose electric power production capacity would be insufficient to adequately provide power to the motorized electric shade. Third, the indoors solar panel would have low efficiency, as it receives—at best—partial and obstructed sunlight, degraded and reduced through a glass window, often at a non-optimal angel or orientation.

The Applicant has developed an innovative system that may solve or mitigate or prevent some or all of these problems; and that may enable efficient and rapid installation/deployment of motorized electric shades, without drilling or forming any holes or tunnels through wall(s) or through window(s) of the venue, and without running an electric cable through such hole/tunnel that goes through a wall/window of the venue.

The Applicant has realized that most residential windows use Single Strength glass, which is 3/32 inch thick, or approximately 2.4 millimeter thick; or sometimes use Double Strength glass, which is ⅛ inch thick, or approximately 3.2 millimeter thick; or sometimes use (foe very large residential windows) glass that is 5/32 inch (4 millimeters) thick or 3/16 inch (4.8 millimeters) thick.

The Applicant has realized that these thickness values of a glass window, may allow to wirelessly transport electric energy—particularly solar-generated electricity—that was generated outdoor (externally to a house or venue), into such house or venue, via a Wireless Energy Transport Mechanism; such as, by placing a Qi energy transmitter unit on (or at, or near) the external side (the outdoor side) of the glass window, and by placing a Qi energy receiver unit on (or at, or near) the internal side (the indoor side) of the glass window. The Applicant has realized that the typical thickness of glass windows is well below/within the range of effective energy transmission between such Qi energy transmitter and Qi receiver, as the official range of Qi energy transmission is around 40 millimeters. Thus, realized the Applicant, a system can be constructed to provide electricity into a venue, from a solar panel located outside the venue, without requiring to drill or to use any holes or tunnels through wall/s of the venue. Such innovative system, realized the Applicant, can be particularly beneficial to slowly or gradually charge or recharge a battery of an electric device or appliance or electronic device, that is located within the venue; and particularly an electric device that is operating only once per several minutes or once per several hours, such as an electric shade unit, or a garage door, or the like.

In accordance with some embodiments of the present invention, a solar panel is installed or mounted or placed outdoors, externally to the house or venue; such as, connected to an external side of an external wall of the venue, or installed or mounted on a roof of the venue, or installed by merely being placed externally to the venue (e.g., being placed outdoors on an outdoor lawn/porch/balcony/yard/floor, or optionally on a raised object).

The outdoor solar panel receives direct sunlight, directly from the sun, without such sunlight going through any glass window/plastic window/transparent window; and thus, such outdoor solar panel has optimal or increased efficiency in collection of sunlight and/or in conversion of such sunlight into electric energy via the photovoltaic effect.

Optionally, the outdoor solar panel may be operably associated with a sun-tracking sensor, that locally tracks the location or direction of the sun, and/or that receives a signal (e.g., over a wireless communication link, such as over Wi-Fi) from a remote server that indicates the current location of the sun; and an outdoor electric motor (which by itself can be powered by that same outdoor solar panel) which rotates/pivots/spins/moves/re-orients the outside solar panel towards the sun to increase its sunlight collection capability and/or its electricity production capability.

The electric energy that is generated by the outdoor solar panel, is transported over an outdoor wire to a Wireless Energy Transmitter Unit, that is located adjacently to the external-side of a glass window of the venue. The outdoor wire can be long, such as 10 or 20 meters long, transporting the solar-generated electricity from the roof to near a ground-floor window to the Wireless Energy Transmitter Unit; or can be short, such as 0.50 or 1 meter long, transporting the solar-generated electricity from the outdoor solar panel that is installed on an outside wall of the venue to the Wireless Energy Transmitter Unit of a nearby window of the venue.

The Wireless Energy Transmitter Unit (e.g., a Qi energy transmitter unit) can be installed on the external side of the window itself; such as, by gluing or bonding, or by using adhesive material or adhesive tape(s), by using double-sided adhesive tape, or by using super-flue or other strong glue or permanent glue or temporary glue, or via suction cup(s) or vacuum cup(s); or by being hung from a nail/a screw/a pin that is hammered or screwed or pushed into the external side of the window frame or into the external side of the wall (without drilling or using any tunnel through such wall or through such window frame), similar to hanging a small painting on a nail such that the painting hangs over part of the window. In some embodiments, optionally, the outdoor Qi unit and the indoor Qi unit may be mechanically connected to two opposite-polarity strong magnets, such that the two Qi units can hold each other via magnetic force at two opposing sides of a thin glass window; or, the two Qi units may be dangling from such two opposite-polarity strong magnets, to enable magnetic holding of the two strong magnets at two opposite sides of the thin glass window while also keeping magnetic interference away from the copper/metal coils that enable inductive power transmission

The Wireless Energy Transmitter Unit transmits/conveys/transports the solar-generated electric energy, typically over a short distance of just 1 or 2 centimeters, via a Wireless Energy Transport protocol/standard/channel; such as, over a Qi or Qi-1 or Qi-2 wireless energy transport channel, or over future versions of Qi wireless energy transport specifications, or over MagSafe or other wireless energy transport mechanisms.

The wirelessly-transported solar-generated energy is immediately received and collected, through the glass window (or plastic window, or transparent window, or other type of window) by a Wireless Energy Receiver Unit (e.g., a Qi wireless energy receiver unit); that is located indoors, inside the venue, immediately on the inner side of the window or adjacent to it.

The Wireless Energy Receiver Unit (e.g., a Qi wireless energy receiver unit) can be installed on the internal (indoor) side of the window itself; such as, by gluing or bonding, or by using adhesive material or adhesive tape(s), by using double-sided adhesive tape, or by using super-flue or other strong glue or permanent glue or temporary glue, or via suction cup(s) or vacuum cup(s); or by being hung from a nail/a screw/a pin that is hammered or screwed or pushed into the indoor side of the window frame or into the indoor side of the wall (without drilling or using any tunnel through such wall or through such window frame), similar to hanging a small painting on a nail such that the painting hangs over part of the window.

The electric energy that is received wirelessly (e.g., over the Qi energy transport link), through the glass window, by the indoor Wireless Energy Receiver Unit, is then utilized and/or transported indoors within the venue, for one or more purposes, such as: (1) to directly supply electric power to an electric motor of a motorized electric shade unit, which can thus open or close that electric shade; and/or (2) to charge or recharge a rechargeable battery, located indoors within the venue, which in turn provides power to an electric motor of an electric shade unit, which can thus open or close the electric shade; and/or (3) optionally, to provide or transport electric power via one or more cables or wires, from the indoor Wireless Energy Receiver Unit, to other power-consuming appliances or devices within the venue, and/or to charge or recharge one or more rechargeable batteries or power cells of such appliances or devices within the venue, such as, to provide power to a laptop computer, a smartphone, a tablet, a gaming device, a television, a computer monitor or display unit, a backup power storage cell (e.g., that can store electricity which can be used if/when there is a power outage), a portable electric power bank, a garage door motor and its battery, a fan or a ceiling fan, an air conditioning unit, a heating unit, a cooling unit, a retractable awning unit or pergola, or the like.

In some embodiments, the electric energy that is received wirelessly (e.g., over the Qi energy transport link), through the glass window, by the Wireless Energy Receiver Unit, is provided to such power-consuming appliances or devices, and/or to the electric motor of an electric shade unit, and/or to the rechargeable battery of the electric shade unit, via one or more wires or cables.

In some embodiments, the electric energy that is received wirelessly (e.g., over the Qi energy transport link), through the glass window, by the Wireless Energy Receiver Unit, is provided to such power-consuming appliances or devices, or to the motor of the electric shade unit, or to the rechargeable battery of the electric shade unit, over a secondary Wireless Energy Transport Link, or via a chain of such Wireless Energy Transport Link. For example, an outdoor Qi Transmitter Tx-1 is located outdoors, and receives solar-generated electricity from the outdoor solar panel; and transmits the solar-generated energy, through the glass window, to indoor Qi Receiver Rx-1 that is located indoors near or on that same window; and the energy transport link from Tx-1 to Rx-1 is utilized mainly for traversing the glass window; then, the indoor Qi Receiver Rx-1 immediately transports the received energy, over a short-distance wire (e.g., 1 or 2 or 5 centimeters) to a nearby/co-located indoor Qi Transmitter Tx-2, which wirelessly transmits the energy to another Qi Receiver Rx-2; and so forth, each such Tx-Rx link extending the chain by a few centimeters, until a final Qi Receiver Tx-n receives the energy and uses it to provide electric power to an electric motor and/or to an electronic device and/or to a rechargeable battery or power cell.

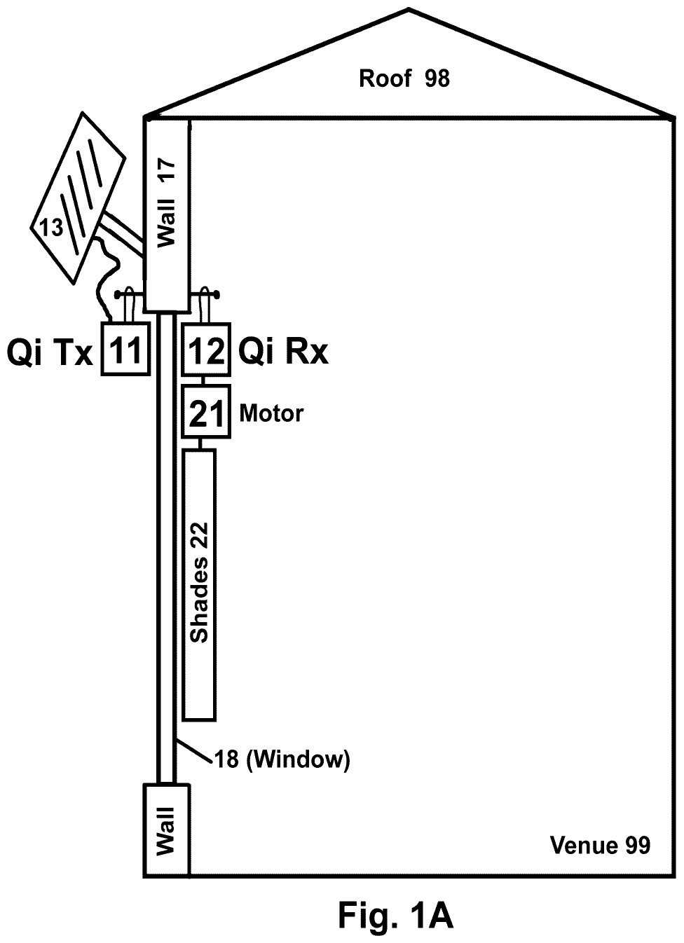

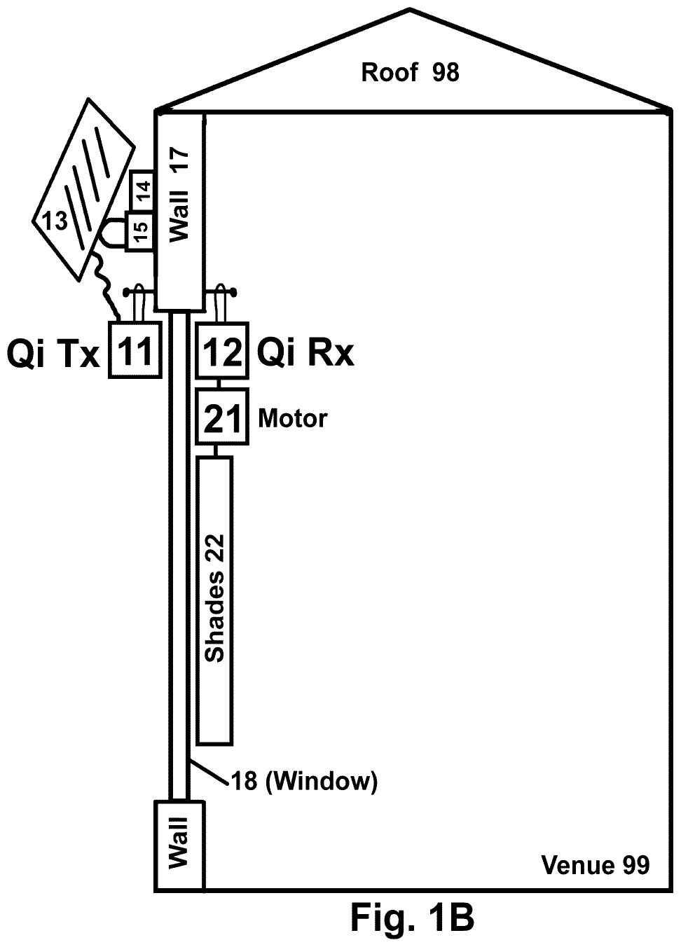

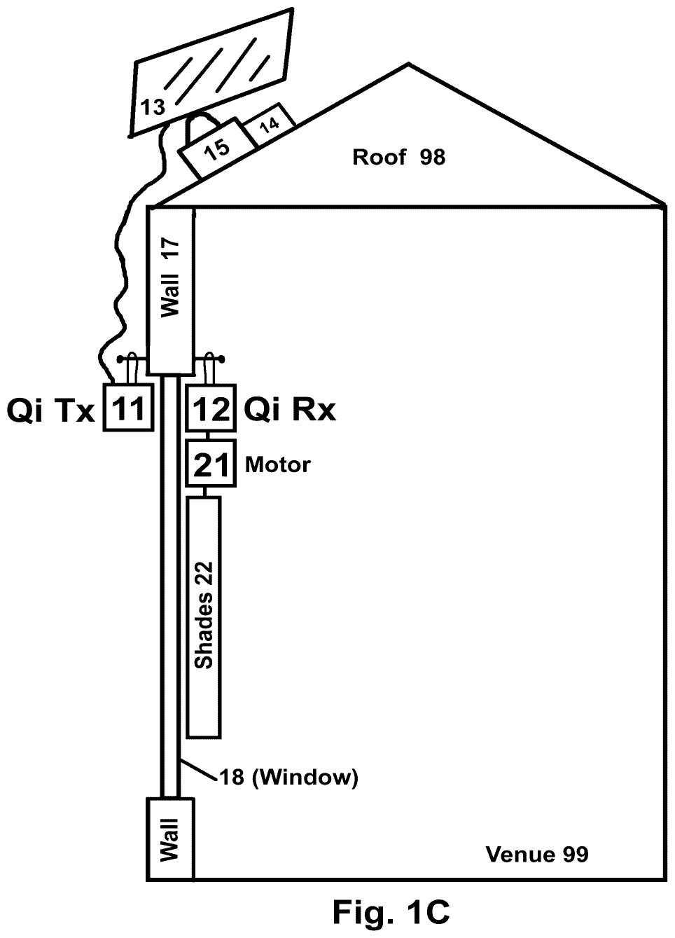

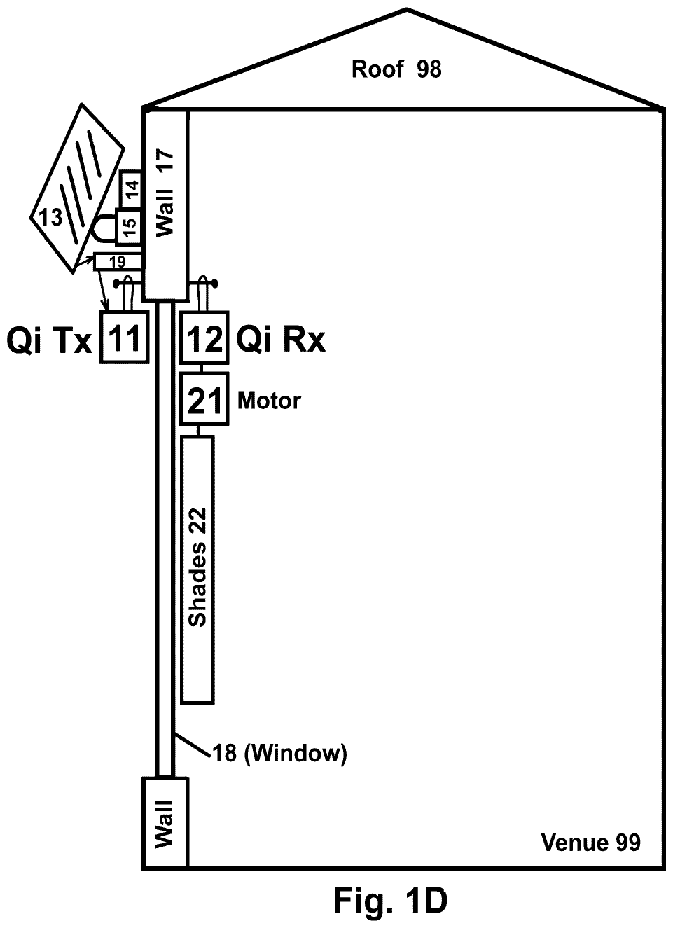

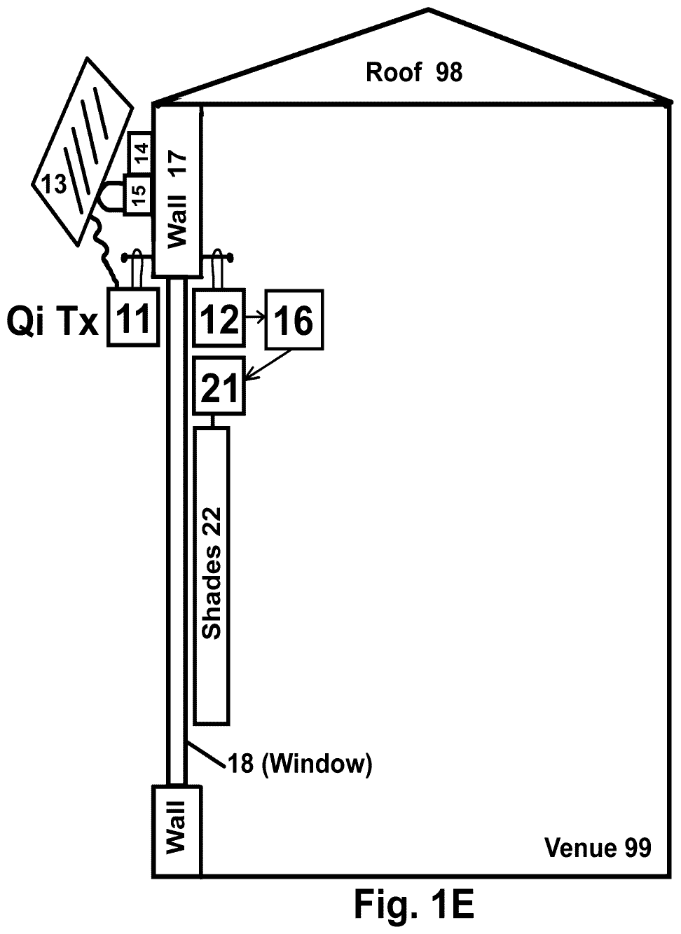

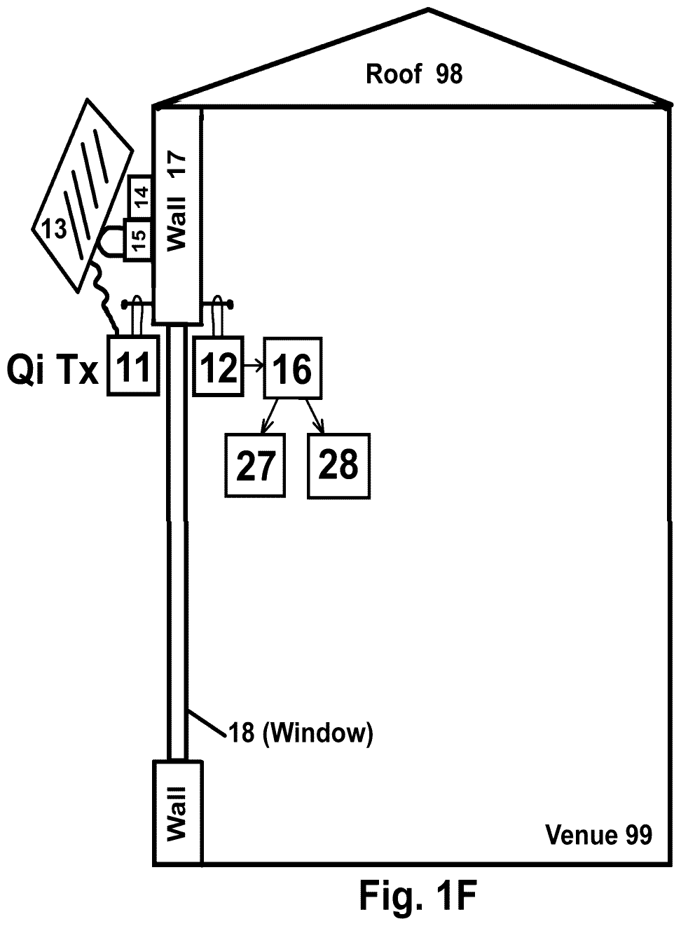

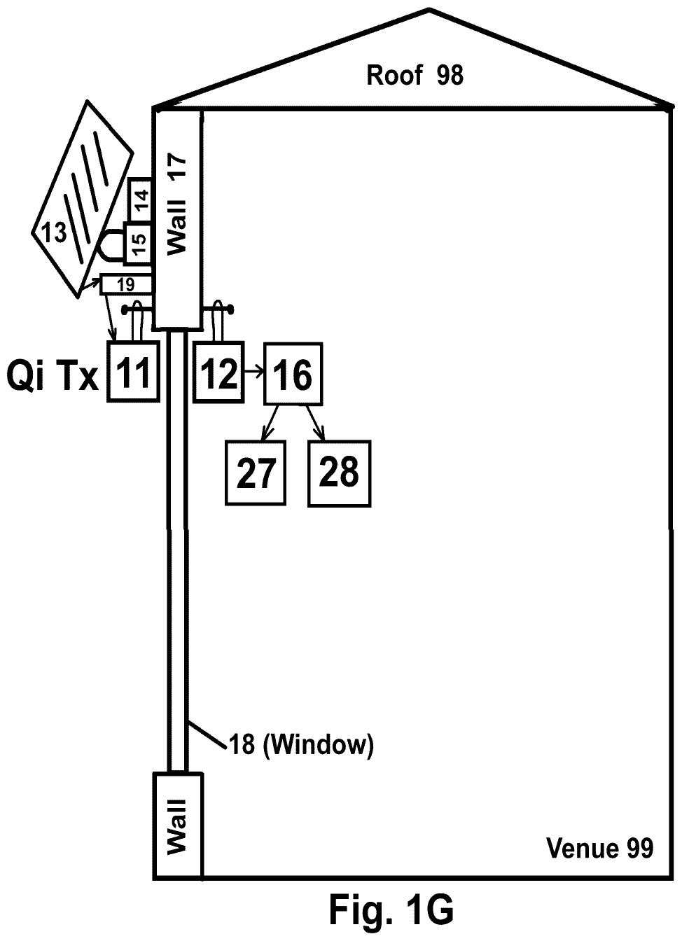

Reference is made to FIG. 1A, which is a schematic illustration of a system, in accordance with some demonstrative embodiments.

Venue 99 may be a home or house or apartment or office or other structure. It has walls 17, made of bricks or wood or other materials; and having a Glass Window 18, which is typically thinner than the wall. It may have a roof 98, which may be slanted or may be horizontal.

For demonstrative purposes, element 18 is referred to as a Glass Window; however, it may be a non-glass window, a fiber-glass window, a plastic window, a transparent window, semi-transparent window, a translucent window, a semi-translucent window, or the like.

Optionally, element 18 may be a similar, transparent, Non-Window element which can fit in a cavity of the wall of the venue; such as: a glass door, a sliding door, a screen door, a net/mesh door, a net/mesh window, or the like.

In some embodiments, Venue 99 may be a vehicle (car, truck, EV or electric vehicle, ICE vehicle or gas-powered vehicle), or a marine vessel (boat, ship, yacht), or an aircraft (airplane, helicopter, jet plane), or a spacecraft (spaceship, space shuttle, space rocket, space capsule), or other structure (e.g., Lunar habitat, Martian habitat, other out-of-Earth habitat).

Outdoor Solar Panel 13 is installed externally to the venue. It can be stationary or fixed; or it can be manually pivoted/rotated/oriented/slanted via a manual mechanical element (e.g., a pivoting element, a rotation element, a gimbal element); or it can be automatically/electrically pivoted/rotated/oriented/slanted via an electric-powered pivoting/rotation/spinning/re-orienting/slanting/moving element or gimbal and an associated electric motor (which, in turn, can be powered by that same outdoor solar panel, and/or by its own power supply or battery); and/or may optionally be associated with a sun-tracking/light-tracking sensor or receiver, which can locally sense or estimate the sun's direction relative to that solar panel, and/or which can receive (e.g., wirelessly) a signal from a remote transmitter/a remote server indicating the sun's location or direction, and/or which may locally compute (autonomously) the sun's location or direction based on a GPS unit (or based on a pre-programmed/one-time configuration of its longitude/latitude data) and by knowing the current date and time (e.g., using a Real Time Clock (RTC) unit which may be programmed one time upon installation). Such a Sun/Light Tracking Unit 14, as well as a Pivoting/Gimbaling Unit 15, are shown in FIG. 1B.

The Outdoor Solar Panel 13 receives or collects light or sunlight, and converts it to electricity via the photovoltaic effect. The generated electricity is transported over an Outdoor Wire to an Outdoor Qi Wireless Energy Transmitter 11, which is located immediately outside the glass window 18, or externally and adjacently to the outer side of the glass window 18.

The Outdoor Qi Wireless Energy Transmitter 11 transmits the energy through the glass window 18, and the energy is almost immediately received, only one or two centimeters away, at an Indoor Qi Wireless Energy Receiver 12 that is located internally within the venue 99.

The Indoor Qi Wireless Energy Receiver 12 may provide the electric energy over an Indoor Wire directly to a nearby Electric Shade Motor 21 of an Electric Shades Unit, to enable the Electric Shade Motor 21 to operate and to close/open one or more Movable Shades Element(s) 22 of that Electric Shades Unit (e.g., a screen or shade that can extend downwardly or retract upwardly; a set of horizontal panels that can spin or rotate along a horizontal axis, to change from a light-blocking position to a light-passage position or vice versa; a set of vertical panels that can spin or rotate along a vertical axis, to change from a light-blocking position to a light-passage position or vice versa).

Additionally or alternatively, the Indoor Qi Wireless Energy Receiver 12 may provide the electric energy over an Indoor Wire to an Indoor Rechargeable Battery, which in turn may provide power (over an indoor wire) to the Electric Shade Motor 21 of the Electric Shades Unit.

Additionally or alternatively, the Indoor Qi Wireless Energy Receiver 12 may provide the electric energy over an Indoor Wire to an Indoor Rechargeable Battery, which in turn may provide electric power (over an indoor wire) to one or more other appliances and/or electric devices and/or electronic devices within the venue; such as to Appliance/Electric Device 32.

Reference is made to FIG. 1B, which is a schematic illustration of another system, in accordance with some demonstrative embodiments. It demonstrates the outdoor Sun/Light Tracking Unit 14, as well as the Pivoting/Gimbaling Unit 15.

Reference is made to FIG. 1C, which is a schematic illustration of another system, in accordance with some demonstrative embodiments. It demonstrates that the Outdoor Solar Panel 13 can be located or mounted on a roof of the venue; and further shows a long outdoor cable or a long outdoor wire for transporting the solar-generated energy to the outdoor Qi Wireless Energy Transmitter Unit 11.

Reference is made to FIG. 1D, which is a schematic illustration of another system, in accordance with some demonstrative embodiments. It demonstrates an Outdoor Rechargeable Battery 19 (or a capacitor or super-capacitor), which firstly accumulates and stores outdoors (outside of the venue 99) the solar-generated electricity that was generated by the outdoor solar panel 13; and it feeds power—continuously or at pre-defined time-intervals (e.g., for T seconds every M minutes; such as, for 15 seconds every 2 minutes)—to the Outdoor Qi Wireless Energy Transmitter 11, which then transmits it wirelessly, through the glass window 18, into the venue 99; where it is received by the Indoor Qi Wireless Energy Receiver 12. Such configuration may enable continuous or on-demand or time-controlled or interval-based wireless transmission of energy, even at night time and/or when there is no active collection of light or sunlight and/or when there is not active production of electricity via the photovoltaic effect. Additionally or alternatively, it may enable to place a larger Outdoor Rechargeable Battery 19 having a larger capacity, located outdoor and externally to the venue 99, accumulating a larger amount of solar-generated power; and then, transporting wirelessly that stored solar-generated power into the venue 99, via the Qi wireless energy transport mechanism through the glass window 18, to a smaller-size/smaller-capacity battery (or several such batteries) located indoors, which does not clutter or disturb the indoor organization or appearance of the venue's room/living room/bedroom.

Reference is made to FIG. 1E, which is a schematic illustration of another system, in accordance with some demonstrative embodiments. It demonstrates an Indoor Rechargeable Battery 16 (or capacitor, or super-capacitor), which receives electric power and recharges via a wire directly from the indoor Qi wireless energy receiver unit 12. Then, the Indoor Rechargeable Battery 16 provides electric power to the electric shade motor 21, over a wire. In this embodiment, the indoor Qi wireless energy receiver unit 12 is not directly connected over a wire to the electric shade motor 21. Rather, the indoor Qi wireless energy receiver unit 12 is connected to, and recharges, the Indoor Rechargeable Battery 16; which in turn provides power over a wire to the electric shade motor 21 (and/or to other electric devices/appliances within the venue 99).

Reference is made to FIG. 1F, which is a schematic illustration of another system, in accordance with some demonstrative embodiments. It lacks any electric shade unit, and it demonstrates that the Indoor Rechargeable Battery 16 (or capacitor, or super-capacitor), which receives solar-generated power that was transported through the glass window 18 using the Qi transmitter unit 11 and the Qi receiver unit 12, can store such power indoors and can provide the power to one or more devices or appliances 27-28.

Reference is made to FIG. 1G, which is a schematic illustration of another system, in accordance with some demonstrative embodiments. It lacks any electric shade unit, and it demonstrates the following configuration: the outdoor solar panel 13 generates electricity, which is immediately stored outdoors at the outdoor rechargeable battery 19 (or capacitor, or super-capacitor); the outdoor Qi wireless energy transmitter 11 draws power from that outdoor rechargeable battery 19 and transmits it wirelessly, through the glass window 18, to the indoor Qi wireless energy receiver 12; which in turn provides the wirelessly-received energy to the Indoor Rechargeable Battery 16, which can store such power indoors and can provide the power to one or more devices or appliances 27-28.

In some embodiments, the outdoor Qi wireless energy transmitter may be configured to include its own battery, or may utilize an outdoor rechargeable battery or super-capacitor, by taking into account one or more parameters such as: the Qi wireless energy transmitter unit startup energy; the Qi wireless energy transmitter unit startup time; the wireless energy transmitter unit efficiency as a function of input power; the startup energy and/or startup time of the indoor appliance or the indoor electric device (e.g., the electric shade motor), as well as its charging efficiency as a function of input power. For example, in order to increase the efficiency of the wireless power transmission, these parameters can be measured/monitored/estimated; and efficiency curves or efficiency charts/graphs may be plotted with regard to the Qi transmission efficiency and the electric shade motor charging efficiency (or the indoor battery/appliance charging efficiency). Such graphs may indicate a simple offset linear function, or may indicate an inverted-U shape or an upside-down U shape or an “n” shape. In some embodiments, in order to achieve overall efficiency, the system may be configured to store solar-generated energy, captured from the solar panel, in an outdoor battery or super-capacitor outside, and then pulse the Qi wireless energy transmitter to selectively transmit and to selectively wirelessly deliver power near (or at) the top of that inverted-U efficiency curve. In some embodiments, the higher the startup energies that are required, the larger the outdoor battery needs to be. Simulations or actual measurements and calculations can be used to determine or to estimate optimal or preferred sleep/charge intervals for the Qi wireless energy transmitter unit.

Some embodiments may further utilize Maximum Power Point Tracking (MPPT), in an attempt to operate the solar panel at or near the ideal point (or region) of its Voltage-Current (the V-I) curve, particularly as the incoming sunlight/illumination varies over time. MPPT may be implemented in the system of some embodiments, in conjunction with voltage sensing and current sensing; and using MPPT can (in some embodiments) provide a 25 to 50 percent increase in available energy (particularly in low-light conditions).

In some embodiments, the energy efficiency may be further improved by modifying/configuring the indoor device that is being charged, such as the electric shade motor. For example, some conventional electric motor may have a high “fixed energy cost” for charging; and they may exit from “sleep mode” whenever a charger is attached, assuming that there is mains power available. In contrast, a modified electric motor or electric shade motor of some embodiments may be configured to detect (e.g., via a USB-C connector which provides a debugging interface) that the motor is actually connected to a solar-generated/photovoltaic power source or to a battery power source or to a non-mains power source, and then remain in a low-power mode so as to improve the overall charge efficiency.

In some embodiments, one of the devices in venue 99, such as device 28, may be a Home Automation Device (HAD) or a smart home hub, optionally including a voice-controlled/voice-assisted bot (e.g., similar to Apple Siri or to Amazon Alexa), configured to wirelessly control one or more other devices/appliances in that venue, particularly via wireless signals conveyed from the HAD over Wi-Fi/Radio Frequency/Bluetooth/Zigbee/InfraRed/MQTT, directly and/or via a local Wi-Fi router and/or via a cloud-computing server (e.g., the HAD sending a command over Wi-Fi and then Internet to a remote server; and the remote server sending the command over Internet and then Wi-Fi to the relevant device in venue 99). The HAD can activate/deactivate such devices, and/or modify their properties or operational parameters. For example, the HAD may receive a voice command such as “Alexa, open the shades in the kitchen”; may perform speech-to-text conversion of the captured audio; may perform textual and/or contextual analysis to extract a machine-executable command; may construct a suitable message or signal, directed to a particular shades unit (Shades #4, located in the kitchen) and indicating the required action (retract that shades unit to expose the window); and may then transmit the message/signal to that particular unit, directly or indirectly. The HAD need not necessarily be powered by the indoors rechargeable battery; but rather, may be powered by its own battery or by mains electricity. The HAD may have a processor and a memory, and may be programmed to reach determinations/decisions and then execute them; for example, the HAD may be pre-programmed or may be user-configurable, such that a user-command to open Shade 1 will automatically trigger the HAD to also open Shade 2 and Shade 3; or that a user action (without a command) that closes Shade 4, will automatically trigger the HAD to open Shade 5; or that a user-command or user-action to close Shade 6 halfway of its entire length, will automatically trigger the HAD to also close Shade 7 halfway of its entire length or (alternatively) to close Shade 7 to only 40 percent of its entire length such that the lower portions (or hem bars) of Shade 7 and Shade 6 would be at the same vertical level relative to the ground (since they have a different vertical length). The HAD may be configured or programmed to make other suitable determinations, and to automatically command one or more electronic devices or electric devices in the venue to perform them accordingly.

In some embodiments, the outdoors Qi wireless energy transmitter unit may require electric power in order to wirelessly transmit energy across/through the glass window toward the Qi wireless energy receiver. In some embodiments, the Qi wireless energy transmitter unit may receive such power directly from the outdoor solar panel, and/or from the outdoor rechargeable battery, and/or from other outdoor power source. It is noted that in accordance with some embodiments, Qi wireless energy receiver does not need to be equipped with its own battery in order to wirelessly receive energy from the Qi wireless energy transmitter unit.

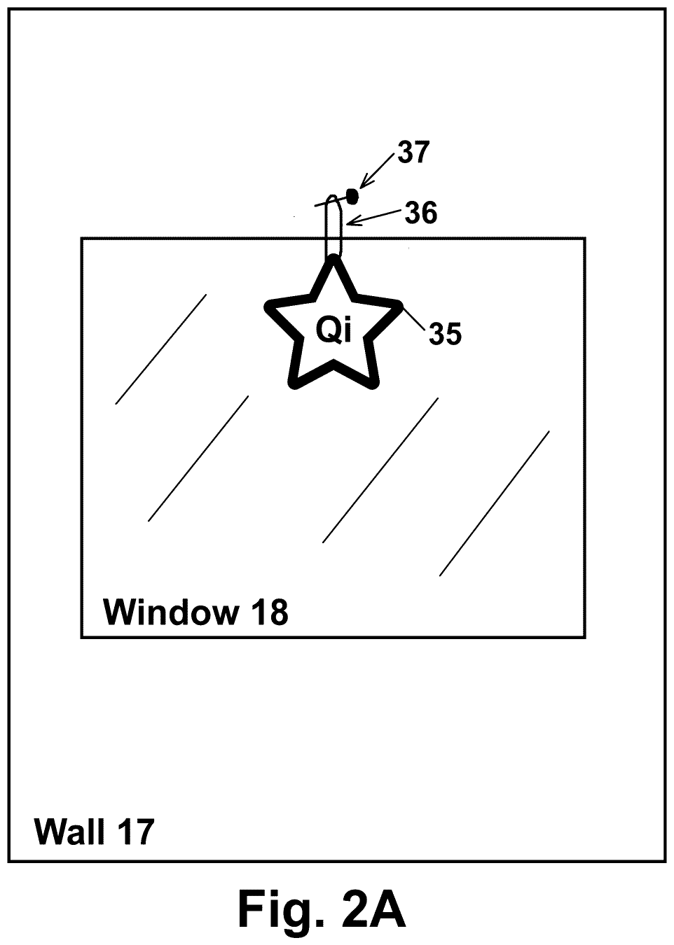

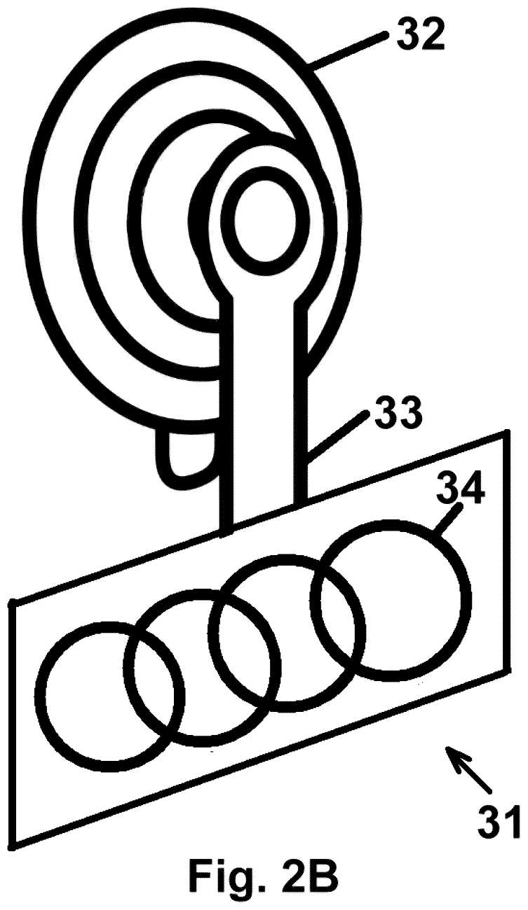

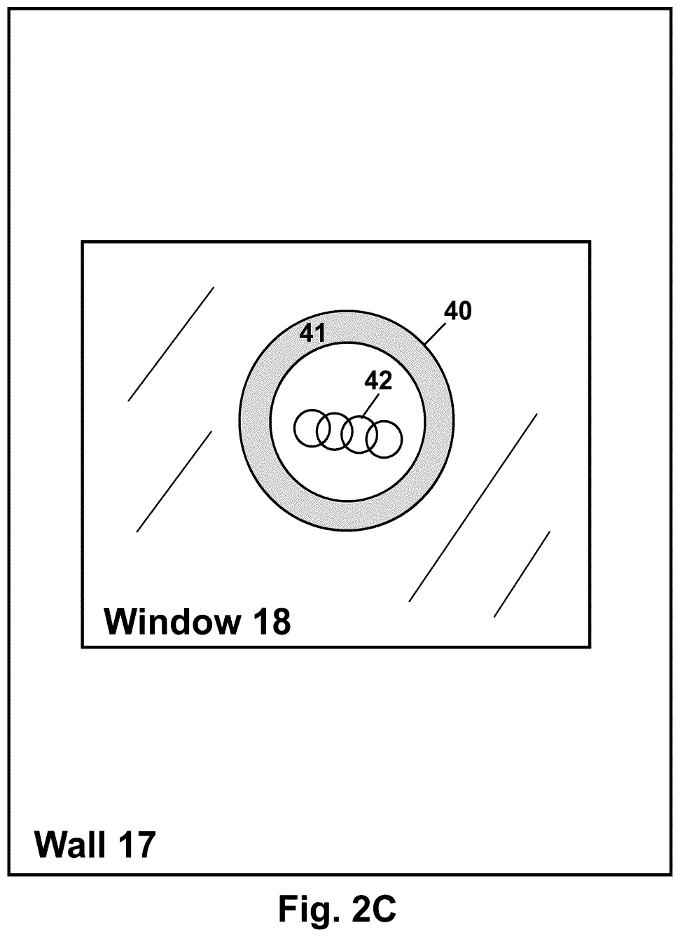

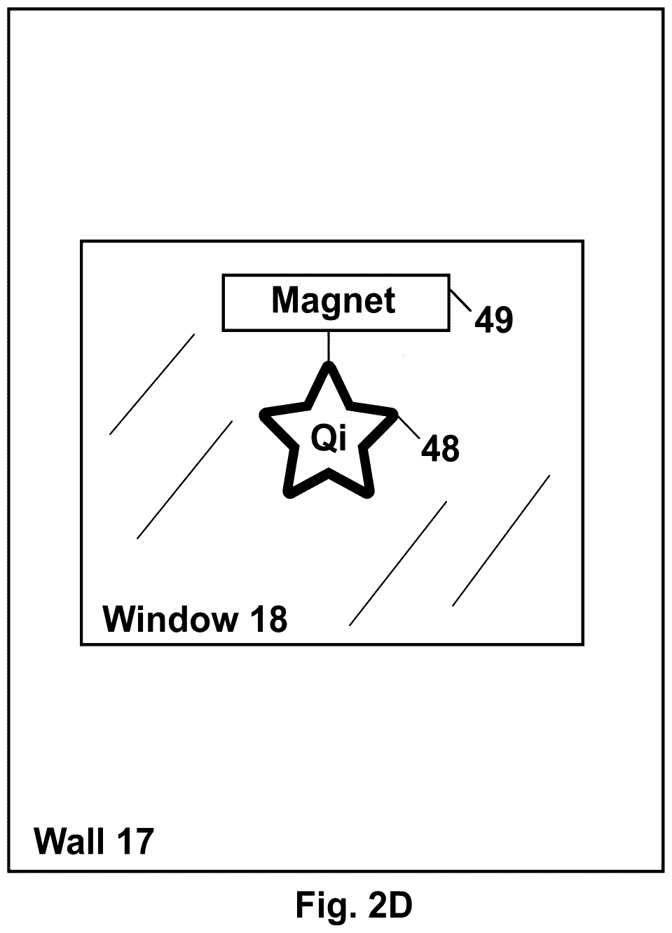

Reference is made to FIG. 2A, which is a schematic illustration of a Qi wireless energy transmitter or receiver 35, structured as a decorative object (e.g., a decorative star), hanging via a thread or loop 36 (e.g., made of nylon, fabric, yarn, metal wire) on (or from) a screw/nail/pin 37 that is on a wall 17 having a window 18, in accordance with some embodiments. It demonstrates one out of several efficient methods to easily place the Qi wireless energy transmitter or receiver adjacently to a glass window, by hanging it on a nail/screw/pin that is above the frame of the window. This can be performed at the indoor side of the window (for the Qi receiver), and similarly at the outdoor side of the window (for the Qi transmitter).

Reference is made to FIG. 2B, which is a schematic illustration of a Qi wireless energy transmitter or receiver 31, structured as a suction cup/vacuum cup 32 having a region or tail or extension 33 (e.g., extending downwardly in this example) that is connected to copper coils or metal coils 34 (e.g., optionally free-standing, or as part of thing frame that surrounds them or holds them), in accordance with some demonstrative embodiments. Such Qi transmitter suction cup may be attached to the outdoors side of the glass window; and such Qi receiver suction cup may be attached to the indoors side of the glass window; and energy may traverse the glass window, transported from the outdoors Qi transmitter to the indoors Qi receiver via tightly-coupled induction or via loosely-coupled induction.

Reference is made to FIG. 2C, which is a schematic illustration of a Qi wireless energy transmitter or receiver unit 40, in accordance with some demonstrative embodiments. One or more copper coils or metal coils 42 are shown; and they are surrounded by a larger magnetic ring 41 that is formed of a strong magnet (e.g., a metal having strong magnetic force). The metal coils 42 may be mechanically connected to the magnetic ring 41 via a plastic member or a thin film or an adhesive element or transparent tape or other mechanical connection/holding elements. The transmitter and receiver have magnetic rings with opposite polarity: for example, the outdoor Qi wireless energy transmitter unit has a first magnetic ring 41 with positive polarity, and the indoor Qi wireless energy receiver unit has a second magnetic ring 41 with negative polarity; or vice versa; such that the two units can be attached to two sides of the same window and can be held in place (and not fall down) due to the magnetic force that pulls them together. The magnetic ring 41 is shown as a ring, for demonstrative purpose; but it can be implemented as a rectangular magnetic frame, a square-shaped magnetic frame, a triangular magnetic frame, or as a magnetic frame having other polygon shape or other shape (e.g., star shaped, for decorative purposes).

Reference is made to FIG. 2D, which is a schematic illustration of a Qi wireless energy transmitter or receiver unit 48, in accordance with some demonstrative embodiments. It hangs via a loop or thread or fabric or wire or plastic connection element, from a large and strong magnetic holding element 49. The transmitter and receiver have magnetic holding elements with opposite polarity: for example, the outdoor Qi wireless energy transmitter unit has a first magnetic holding element 49 with positive polarity, and the indoor Qi wireless energy receiver unit has a second magnetic holding element 49 with negative polarity; or vice versa; such that the two units can be attached to two sides of the same window and can be held in place (and not fall down) due to the magnetic force that pulls them together. The magnetic holding element 49 is shown as a rectangle, for demonstrative purpose; but it can be implemented as a square-shaped magnetic element, a triangular magnetic element, or as a magnetic element having other polygon shape or other shape (e.g., star shaped, for decorative purposes).

Some embodiments may utilize one or more types of wireless energy transport, or through-the-glass-window wireless charging of an indoor rechargeable battery by an outdoor solar panel. Such types may include: (1) tightly-coupled electromagnetic inductive charging or non-radiative charging; (2) charging bowls or through-surface type chargers that use loosely-coupled or radiative electromagnetic resonant charging, that can transmit a charge for a few centimeters; (3) uncoupled radio frequency (RF) wireless charging that allows a trickle charging capability at distances of several meters.

The tightly-coupled inductive charging and the loosely-coupled resonant charging operate on similar principles: a time-varying magnetic field induces a current in a closed loop of wire (e.g., coil/s made of copper or other metal). A magnetic loop antenna (e.g., a copper coil) is used to create an oscillating magnetic field, which can create a current in one or more receiver antennas. If appropriate capacitance is added, such that the loops resonate at the same frequency, the amount of induced current in the receivers increases; achieving resonant inductive charging or magnetic resonance; it enables power transmission at greater distances between transmitter and receiver and it increases efficiency.

In some embodiments, coil size also affects the distance of power transfer: The bigger the coil, or the more coils there are, the greater the distance a charge can travel. Copper coils of only 10 centimeters diameter can enable power travel for several centimeters, which is sufficient to traverse a glass window and is a good alternative to drilling tunnels through walls. When larger coils are used, more energy can be transferred wirelessly.

Some embodiments may utilize across-the-glass-window Radio Charging or RF based charging or RF based energy transport. For example, the outdoor Wireless Energy Transmitter generates RF waves; and an antenna at the indoors Wireless Energy Receiver collects or harvests the RF waves and converts them into energy or Direct Current (DC) voltage. Accordingly, uncoupled RF-based energy transport may be used to transport energy across a glass window.

Some embodiments may transport energy across the glass window by using Magnetic Resonance Charging. A copper coil is in the Wireless Energy Transmitter Unit, and a copper coil is in the Wireless Energy Receiver Unit. A connection is formed when both copper coils are configured to a common electromagnetic frequency, allowing a transfer of energy from the transmitter side over a relatively short distance, which charges the device on the receiving end.

Some embodiments may utilize Inductive Wireless Charging, such as Qi based energy transport. Energy is transferred from a charger to a receiver (from the Energy Transmitter outdoors, to the Energy Receiver indoors) via electromagnetic induction. The energy transmitter unit uses an induction coil to create an electromagnetic field, which the receiver coil in the energy receiver unit converts back into electricity, which is then fed into a rechargeable battery and/or into an electric device.

In some embodiments, single-mode Qi or dual-mode Qi may be used; for example, utilizing Qi energy transport that is compatible with the Wireless Power Consortium (WPC) standards and/or with the Power Matters Alliance (PMA) standards.

In some embodiments, realized the Applicant, the wireless energy transmitter/receiver should preferably remain dry in order to operate efficiently; and thus, it may be coated with a protective coating or layer or thin sleeve, or may be coated or painted or brushed or covered with a water-resistant/water-repelling layer or material or hydrophobic coating or layer or material; or may otherwise be isolated or protected from water/wetness/humidity using a protective sleeve or thin fabric case.

It is noted that in some embodiments, the wireless transport of energy through the glass window, may enable a low or even a very low rate of charting the indoors rechargeable battery, such as providing only 1 or 2 or 3 or 5 Watts (the Qi standard typically provides 5 to 15 Watts); however, realized the Applicant, such embodiments may still be useful and may still provide Utility to the user, particularly in implementations where a device is operated only for a short period of time (e.g., 5 seconds) per day or per half-day. For example, realized the Applicant, some motorized shade units are opened by the user in the morning, and are closed by the user in the evening; and their motor thus operates for five seconds in the morning and for five more seconds in the evening; and the low Wattage that is transported by the Qi wireless energy transport mechanism may suffice to charge the rechargeable battery for two such operations per day.

In some embodiments, optionally, one electric shade unit in the venue, can signal or indicate (e.g., via a wireless communication signal/link) that it is being opened/closed; and in response, another electric shade unit in the same venue, based on that signal, would also open/close itself (entirely, or to the same level/percentage as indicated by the first electric shade unit). In other embodiments, such signal may be provided by a Home Automation Device (HAD) unit or a Smart Home Hub Unit, which can cause one or more particular electric shade units to close/to open, upon detection/determination/user-command to close/to open one other particular electric shade unit; for example, based on pre-defined rules (e.g., if one electric shade unit that faces south is commanded by the user to close, then close all the other electric shade units that also face south in that same venue, that have the same wall, and/or that are in the same room, and/or that are in other rooms of the same venue). Some embodiments may utilize shade-to-shade direct wireless signaling, or shade-to-HAD and HAD-to-shade signaling, to coordinate closure/opening of multiple shade units, or to cause one or more other shade units to close/to open in response to closing/opening of another shade unit, based on pre-programmed and/or user-configurable rules or conditions (e.g., automatically close/open shades that are on the same wall/in the same room/in other rooms).

Some embodiments may include a stand-alone device for wirelessly transporting energy for a short distance (e.g., typically a range of 2 to 4 centimeters) through a glass window (or other window or other obstacle or barrier), without requiring to drill or use any holes/tunnels in such window or its nearby wall/frame. The device has two parts: (I) the first part is a Qi (or other type of) wireless energy transmitter (or “charging unit”), that is located on or at a first side of that window (e.g., the external side of the window), and that receives the electric power over a wire or cable from a power source located on that side (e.g., an outdoors solar panel/power generator/power cell/battery), and that transmits the power wirelessly via a set of copper coils or other metal coils; and, (II) the second part is a Qi (or other type of) wireless energy receiver (or “charge receiver”), that is located on or at a second (opposite) side of that window (e.g., the internal side of the window), and that wirelessly receives the power on its side via its own set of copper coils or metal coils, and provides/outputs that electric power, over a wire or cable, to a nearby electric device or rechargeable battery or power cell. Each of the two parts has a mechanism for efficient attachment to that window; for example, an adhesive or tape, a glue or bonding element, a hanging strap for hanging on a nail/screw/pin, a suction cup/vacuum cup, or the like; such that the two parts of the device are attached, as close as possible to each other, or at a distance of under 4 centimeters of each other, at two sides of the same window.

Some embodiments include a motorized electric shade system, comprising: (a) a movable shade element, located indoors within a venue, and configured to selectively cover and uncover some or all of a glass window of said venue; (b) an electric shade motor, located indoors within said venue, and configured to open and close said movable shade element; (c) an indoors rechargeable electric battery, connected indoors via an indoors wire to said electric shade motor, and configured to provide electric power to said electric shade motor; (d) an indoors wireless energy receiver unit, located indoors internally within said venue, adjacently to said glass window of said venue; (e) an outdoors wireless energy transmitter unit, located outdoors externally to said venue, adjacently to said glass window of said venue; wherein the indoors wireless energy receiver unit is configured to wirelessly receive incoming energy from said outdoors wireless energy transmitter unit over a wireless energy transport medium that wirelessly transports electric energy through said glass window; wherein the wireless energy receiver unit is configured to recharge said rechargeable electric battery by supplying to it said incoming energy that was wirelessly received from said wireless energy transmitter unit; (f) an outdoor photovoltaic solar panel, located outdoors externally to said venue, to receive sunlight and to convert sunlight to electric energy via the photovoltaic effect; wherein electric energy that is generated by the outdoor photovoltaic solar panel is transported over an outdoor wire from the outdoor photovoltaic solar panel to the outdoor wireless energy transmitter unit.

In some embodiments, the outdoors wireless energy transmitter unit is configured to receive electric energy from said outdoor photovoltaic solar panel over said outdoors wire, and to wirelessly transmit electric energy to said indoors wireless energy receiver unit over a Qi wireless energy transport link; wherein the indoors wireless energy receiver unit is configured to wirelessly receive electric energy from said outdoors wireless energy transmitter unit over said Qi wireless energy transport link.

In some embodiments, the outdoors wireless energy transmitter unit is configured to receive electric energy from said outdoor photovoltaic solar panel over said outdoors wire, and to wirelessly transmit electric energy to said indoors wireless energy receiver unit over a Qi-2 wireless energy transport link; wherein the indoors wireless energy receiver unit is configured to wirelessly receive electric energy from said outdoors wireless energy transmitter unit over said Qi-2 wireless energy transport link.

In some embodiments, the outdoors wireless energy transmitter unit is configured to receive electric energy from said outdoor photovoltaic solar panel over said outdoors wire, and to wirelessly transmit electric energy to said indoors wireless energy receiver unit over a MagSafe wireless energy transport link; wherein the indoors wireless energy receiver unit is configured to wirelessly receive electric energy from said outdoors wireless energy transmitter unit over said MagSafe wireless energy transport link.

In some embodiments, the indoors wireless energy receiver unit provides electric energy to said rechargeable electric battery over an indoors wire.

In some embodiments, the indoors wireless energy receiver unit provides electric energy to said rechargeable electric battery over a secondary/indoors wireless energy transport channel, that is different from the wireless energy transport channel that was utilized for traversing the glass window.

In some embodiments, the photovoltaic-generated electric energy, that is generated outdoors by the outdoor photovoltaic solar panel and that recharges said electric battery which powers the electric shade motor, is transported into said venue exclusively over one or more wireless energy transport channels, without drilling or utilizing any drilled tunnels through any wall of said venue.

In some embodiments, the photovoltaic-generated electric energy, that recharges said electric battery which powers the electric shade motor, is generated exclusively by said outdoor photovoltaic solar panel which received sunlight directly from the sun without said sunlight going through any glass window.

In some embodiments, said outdoor photovoltaic solar panel is attached to an outdoors rotating/pivoting member that is configured to rotate or pivot said outdoor photovoltaic solar panel over time to increase sunlight collection.

In some embodiments, said outdoor photovoltaic solar panel is attached to an outdoors rotating/pivoting member that is configured to rotate or pivot said outdoor photovoltaic solar panel over time to increase sunlight collection, based on a signal received from a sun-tracking sensor that indicates to which direction and to what degree the outdoor photovoltaic solar panel should be rotated or pivoted to increase sunlight collection.

In some embodiments, the electric shade motor is configured to selectively cause the movable shade element, to either (i) move downwardly and extend to cover a greater area of said glass window, or (ii) move upwardly and retract to cover a smaller area of said glass window, in response to a command to close or to open, respectively, said movable shade element.

In some embodiments, wherein said command to close or to open said movable shade element is a user-command that is provided to said electric shade motor over an infrared (IR) communication link, from an infrared transmitter operated by a user, to an infrared receiver that is operably associated with said electric shade motor.

In some embodiments, said command to close or to open said movable shade element is a user-command that is provided to said electric shade motor over a Wi-Fi wireless communication link, from a Wi-Fi transmitter operated by a user, to a Wi-Fi receiver that is operably associated with said electric shade motor.

In some embodiments, said command to close or to open said movable shade element is a user-command that is provided to said electric shade motor over a Bluetooth wireless communication link, from a Bluetooth transmitter operated by a user, to a Bluetooth receiver that is operably associated with said electric shade motor.

In some embodiments, said command to close or to open said movable shade element is a wireless signal that is autonomously generated by a Home Automation Device (HAD), that autonomously reaches a determination to close or to open said movable shade element based on one or more conditions or criteria, and that autonomously transported said command wirelessly from a wireless transmitter that is associated with said HAD to a wireless receiver that is associate with said HAD.

In some embodiments, said command to close or to open said movable shade element is a wireless signal that is autonomously generated by a Home Automation Device (HAD), that autonomously reaches a determination to close or to open said movable shade element based on one or more conditions or criteria, and that autonomously transports said command wirelessly from a wireless transmitter that is associated with said HAD to a wireless receiver that is associated with said electric shade motor.

In some embodiments, said command to close or to open said movable shade element is a wireless signal that is autonomously generated by a Home Automation Device (HAD), that autonomously reaches a determination to close or to open said movable shade element based on a determination that another movable shade element is currently being closed or is currently being opened.

In some embodiments, said command to close or to open said movable shade element is a wireless signal that is autonomously generated by a Home Automation Device (HAD), that autonomously reaches a determination to close or to open said movable shade element based on a determination that another movable shade element has been closed in the past T seconds or has been opened in the past T seconds, wherein T is a pre-defined or user-configurable positive number.

In some embodiments, said command to close or to open said movable shade element is a wireless signal that is wirelessly received, at a wireless receiver that is operably associated with said electric shade motor, from a wireless transmitter that is associated with another electric shade motor that controls another movable shade element that covers another glass window in said venue.

In some embodiments, at least one unit of: the indoors wireless energy receiver unit, the outdoors wireless energy transmitter unit, is mechanically connected to a suction cup that holds said unit to said glass window via suction force.

In some embodiments, the indoors wireless energy receiver unit is surrounded by a first magnetic frame having a first magnetic polarity; wherein the outdoors wireless energy transmitter unit is surrounded by a second magnetic frame having a second magnetic polarity that is opposite the first magnetic polarity; wherein the first magnetic frame and the second magnetic frame, when placed at two opposite sides of said glass window, hold in place via magnetic force said indoors wireless energy receiver unit and said outdoors wireless energy transmitter unit.

In some embodiments, the indoors wireless energy receiver unit is mechanically connected to a first magnetic holding element having a first magnetic polarity; wherein the outdoors wireless energy transmitter unit is mechanically connected to a second magnetic holding element having a second magnetic polarity that is opposite the first magnetic polarity; wherein the first magnetic holding element and the second magnetic holding element, when placed at two opposite sides of said glass window, hold in place via magnetic force said indoors wireless energy receiver unit and said outdoors wireless energy transmitter unit.

In some embodiments, the outdoors wireless energy transmitter unit is configured to continuously wirelessly transmit power through said glass window in accordance with a continuous power transmission scheme.

In some embodiments, the outdoors wireless energy transmitter unit is configured to non-continuously wirelessly transmit power through said glass window in accordance with a pulse-based power transmission scheme.

In some embodiments, the outdoors wireless energy transmitter unit is configured to non-continuously wirelessly transmit power through said glass window in accordance with a pulse-based power transmission scheme that is configured based on at least one of (or some of, or most of, or all of): startup time of the outdoors wireless energy transmitter unit; startup energy of the outdoors wireless energy transmitter unit; efficiency of the outdoors wireless energy transmitter unit; startup time of an indoor device that is charged by said power; startup energy of the indoor device that is charged by said power; efficiency of the indoor device that is charged by said power.

For demonstrative purposes, some portions of the discussion and/or the drawings may discuss or may show the Wireless Energy Transmitter unit located outside the venue/outdoor, and the Wireless Energy Receiver unit located inside the venue/indoor; however, their locations may be reversed or switched in order to enable through-the-glass-window (or through-the-physical-barrier) wireless energy transmission from an indoor power source to an outdoor power source. For example, a power bank or a high-capacity battery or a backup battery may be located inside the venue; and may provide power via such through-the-glass-window Wireless Energy Transmission to a set of lights (e.g., LED lights, or illumination units) that are located outside/outdoor. Similarly, for example, a power generator may be located in a garage of a venue, and may provide power via such through-the-glass-window Wireless Energy Transmission to a set of lights or to an electric device that is located outside/outdoor, through a glass window of that garage.

Other configurations may be used to provide power wirelessly, through the glass window or through the barrier, in the direction of outdoor-to-indoor or in the direction of indoor-to-outdoor.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5,CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Some embodiments may perform steps or operations such as, for example, “determining”, “identifying”, “comparing”, “checking”, “querying”, “searching”, “matching”, “estimating”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated or collected data, and one or more values as stored in a look-up table or a legend table or a list of reference value(s) or a database of reference values or a ranges of reference-values; a comparison or matching or searching process which searches for matches and/or identical results and/or similar results and/or sufficiently-similar results (e.g., within a pre-defined threshold level of similarity; such as, within 5 percent above or below a pre-defined threshold value), among multiple values or limits that are stored in a database or look-up table or that are defined by comparison rules or matching rules; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. A motorized electric shade system, comprising:
(a) a movable shade element, located indoors within a venue, and configured to selectively cover and uncover some or all of a glass window of said venue;
(b) an electric shade motor, located indoors within said venue, and configured to open and close said movable shade element;
(c) an indoors rechargeable electric battery, connected indoors via an indoors wire to said electric shade motor, and configured to provide electric power to said electric shade motor;
(d) an indoors wireless energy receiver unit, located indoors internally within said venue, adjacently to said glass window of said venue;
(e) an outdoors wireless energy transmitter unit, located outdoors externally to said venue, adjacently to said glass window of said venue, and configured to wirelessly transmit energy to said indoors wireless energy receiver unit through said glass window;
wherein the indoors wireless energy receiver unit is configured to wirelessly receive incoming energy from said outdoors wireless energy transmitter unit over a wireless energy transport medium that wirelessly transports electric energy through said glass window;
wherein the wireless energy receiver unit is configured to recharge said rechargeable electric battery by supplying to it said incoming energy that was wirelessly received from said wireless energy transmitter unit;
(f) an outdoor photovoltaic solar panel, located outdoors externally to said venue, to receive sunlight and to convert sunlight to electric energy via the photovoltaic effect;
wherein electric energy that is generated by the outdoor photovoltaic solar panel is transported over an outdoor wire from the outdoor photovoltaic solar panel to the outdoor wireless energy transmitter unit.

2. The motorized electric shade system of claim 1,
wherein the outdoors wireless energy transmitter unit is configured to receive electric energy from said outdoor photovoltaic solar panel over said outdoors wire, and to wirelessly transmit electric energy to said indoors wireless energy receiver unit over a Qi wireless energy transport link;
wherein the indoors wireless energy receiver unit is configured to wirelessly receive electric energy from said outdoors wireless energy transmitter unit over said Qi wireless energy transport link.

3. The motorized electric shade system of claim 1,
wherein the outdoors wireless energy transmitter unit is configured to receive electric energy from said outdoor photovoltaic solar panel over said outdoors wire, and to wirelessly transmit electric energy to said indoors wireless energy receiver unit over a Qi-2 wireless energy transport link;
wherein the indoors wireless energy receiver unit is configured to wirelessly receive electric energy from said outdoors wireless energy transmitter unit over said Qi-2 wireless energy transport link.

4. The motorized electric shade system of claim 1,
wherein the outdoors wireless energy transmitter unit is configured to receive electric energy from said outdoor photovoltaic solar panel over said outdoors wire, and to wirelessly transmit electric energy to said indoors wireless energy receiver unit over a MagSafe wireless energy transport link;
wherein the indoors wireless energy receiver unit is configured to wirelessly receive electric energy from said outdoors wireless energy transmitter unit over said MagSafe wireless energy transport link.

5. The motorized electric shade system of claim 1,
wherein the indoors wireless energy receiver unit provides electric energy to said rechargeable electric battery over an indoors wire.

6. The motorized electric shade system of claim 1,
wherein the indoors wireless energy receiver unit provides electric energy to said rechargeable electric battery over an indoors wireless energy transport channel.

7. The motorized electric shade system of claim 1,
wherein photovoltaic-generated electric energy,
that is generated outdoors by the outdoor photovoltaic solar panel and that recharges said electric battery which powers the electric shade motor,
is transported into said venue exclusively over one or more wireless energy transport channels, without drilling or utilizing any drilled tunnels through any wall of said venue.

8. The motorized electric shade system of claim 1,
wherein photovoltaic-generated electric energy,
that recharges said electric battery which powers the electric shade motor,
is generated exclusively by said outdoor photovoltaic solar panel which received sunlight directly from the sun without said sunlight going through any glass window.

9. The motorized electric shade system of claim 1,
wherein said outdoor photovoltaic solar panel is attached to an outdoors rotating/pivoting member that is configured to rotate or pivot said outdoor photovoltaic solar panel over time to increase sunlight collection.

10. The motorized electric shade system of claim 1,
wherein said outdoor photovoltaic solar panel is attached to an outdoors rotating/pivoting member that is configured to rotate or pivot said outdoor photovoltaic solar panel over time to increase sunlight collection,
based on a signal received from a sun-tracking sensor that indicates to which direction and to what degree the outdoor photovoltaic solar panel should be rotated or pivoted to increase sunlight collection.

11. The motorized electric shade system of claim 1,
wherein the electric shade motor is configured to selectively cause the movable shade element, to either (i) move downwardly and extend to cover a greater area of said glass window, or (ii) move upwardly and retract to cover a smaller area of said glass window,
in response to a command to close or to open, respectively, said movable shade element.

12. The motorized electric shade system of claim 11,
wherein said command to close or to open said movable shade element is a user-command that is provided to said electric shade motor over an infrared (IR) communication link, from an infrared transmitter operated by a user, to an infrared receiver that is operably associated with said electric shade motor.

13. The motorized electric shade system of claim 11,
wherein said command to close or to open said movable shade element is a user-command that is provided to said electric shade motor over a Wi-Fi wireless communication link, from a Wi-Fi transmitter operated by a user, to a Wi-Fi receiver that is operably associated with said electric shade motor.

14. The motorized electric shade system of claim 11,
wherein said command to close or to open said movable shade element is a user-command that is provided to said electric shade motor over a Bluetooth wireless communication link, from a Bluetooth transmitter operated by a user, to a Bluetooth receiver that is operably associated with said electric shade motor.

15. The motorized electric shade system of claim 11,
wherein said command to close or to open said movable shade element is a wireless signal that is autonomously generated by a Home Automation Device (HAD),
that autonomously reaches a determination to close or to open said movable shade element based on one or more conditions or criteria,
and that autonomously transports said command wirelessly from a wireless transmitter that is associated with said HAD to a wireless receiver that is associated with said electric shade motor.

16. The motorized electric shade system of claim 11,
wherein said command to close or to open said movable shade element is a wireless signal that is autonomously generated by a Home Automation Device (HAD), that autonomously reaches a determination to close or to open said movable shade element based on a determination that another movable shade element is currently being closed or is currently being opened.

17. The motorized electric shade system of claim 11,
wherein said command to close or to open said movable shade element is a wireless signal that is autonomously generated by a Home Automation Device (HAD), that autonomously reaches a determination to close or to open said movable shade element based on a determination that another movable shade element has been closed in the past T seconds or has been opened in the past T seconds, wherein T is a pre-defined or user-configurable positive number.

18. The motorized electric shade system of claim 11,
wherein said command to close or to open said movable shade element is a wireless signal that is wirelessly received, at a wireless receiver that is operably associated with said electric shade motor, from a wireless transmitter that is associated with another electric shade motor that controls another movable shade element that covers another glass window in said venue.

19. The motorized electric shade system of claim 1,
wherein at least one unit of: the indoors wireless energy receiver unit, the outdoors wireless energy transmitter unit, is mechanically connected to a suction cup that holds said unit to said glass window via suction force.

20. The motorized electric shade system of claim 1,
wherein the indoors wireless energy receiver unit is surrounded by a first magnetic frame having a first magnetic polarity;
wherein the outdoors wireless energy transmitter unit is surrounded by a second magnetic frame having a second magnetic polarity that is opposite the first magnetic polarity;
wherein the first magnetic frame and the second magnetic frame, when placed at two opposite sides of said glass window, hold in place via magnetic force said indoors wireless energy receiver unit and said outdoors wireless energy transmitter unit.

21. The motorized electric shade system of claim 1,
wherein the indoors wireless energy receiver unit is mechanically connected to a first magnetic holding element having a first magnetic polarity;
wherein the outdoors wireless energy transmitter unit is mechanically connected to a second magnetic holding element having a second magnetic polarity that is opposite the first magnetic polarity;
wherein the first magnetic holding element and the second magnetic holding element, when placed at two opposite sides of said glass window, hold in place via magnetic force said indoors wireless energy receiver unit and said outdoors wireless energy transmitter unit.

22. The motorized electric shade system of claim 1,
wherein the outdoors wireless energy transmitter unit is configured to continuously wirelessly transmit power through said glass window in accordance with a continuous power transmission scheme.

23. The motorized electric shade system of claim 1,
wherein the outdoors wireless energy transmitter unit is configured to non-continuously wirelessly transmit power through said glass window in accordance with a pulse-based power transmission scheme.

24. The motorized electric shade system of claim 1,
wherein the outdoors wireless energy transmitter unit is configured to non-continuously wirelessly transmit power through said glass window in accordance with a pulse-based power transmission scheme that is configured based on at least one of:
startup time of the outdoors wireless energy transmitter unit;
startup energy of the outdoors wireless energy transmitter unit;
efficiency of the outdoors wireless energy transmitter unit;
startup time of an indoor device that is charged by said power;
startup energy of the indoor device that is charged by said power;
efficiency of the indoor device that is charged by said power.
